(19) United States
(12) Patent Application Publication
(10) Pub. No.: US 2022/0050885 A1
(43) Pub. Date: Feb. 17, 2022

(54) FAVORITES MANAGEMENT AND INFORMATION SEARCH SERVICE PROVIDING SYSTEM AND FAVORITES MANAGEMENT AND INFORMATION SEARCH SERVICE PROVIDING METHOD USING SAME

(71) Applicant: Jun KIM, Cheonan-si (KR)

(72) Inventor: Jun KIM, Cheonan-si (KR)

(21) Appl. No.: 17/296,893

(22) PCT Filed: Nov. 21, 2019
(86) PCT No.: PCT/KR2019/016064

§ 371 Date: May 25, 2021

(30) Foreign Application Priority Data
Nov. 26, 2018 (KR) 10-2018-0147022

(51) Int. Cl. G06F 16/955; G06F 16/953; G06F 40/40

(52) U.S. Cl. CPC G06F 16/9562; G06F 16/953; G06F 40/40; G06F 16/9566; G06F 16/9558

(57) ABSTRACT

The present invention relates to a favorites management and information search service providing system and a favorites management and information search service providing method using same. According to the present invention, by resolving problems in favorites systems and methods of an existing technology in which a user has to individually add web pages visited by the user to favorites and thus favorites items are difficult to manage and inconvenient to use as the number of the favorites items increases, a user can add a relevant web page to favorites simply by clicking the address of a favorites management website, can easily manage the stored favorites items and can easily share with other users. Also, when the user inputs a search word, the search word is analyzed and search results from a plurality of preset search engines and websites are provided simultaneously. If a website is in a foreign language, an automatic translation into a national language is provided. Therefore, the user can more conveniently store and use favorites and also quickly and easily receive desired search results.

### TECHNICAL FIELD

The present invention relates to a bookmark management system and method for allowing a user to more conveniently save and use bookmarks, and more specifically, to a bookmark management and information search service providing system in which, by solving a problem of the conventional bookmark system and method that are difficult to manage and inconvenient to use as the number of bookmarks increases because a bookmark should be set for each web page that a user visits, a bookmark for a corresponding web page is simply settable by clicking an address of a bookmark management website on the web page that the user is currently visiting, saved bookmarks are easily manageable, and the bookmarks are easily sharable with another user, and a bookmark management and information search service providing method using the same.

Further, in addition to being configured to easily save and manage the bookmarks as described above, the present invention relates to a bookmark management and information search service providing system in which, when a user enters a search word, the corresponding search word is analyzed and results retrieved from a plurality of preset search engines and websites are provided so that the user may rapidly and easily obtain a desired search result without having to visit a specific website or search engine and, at the same time, when the website is a web site in a foreign language, the content of the web site is translated into the content in a native language, thereby easily performing a global search using Hangul, and a bookmark management and information search service providing method using the same.

### BACKGROUND ART

Recently, with the development of the Internet, it has become common for each individual to access the Internet to perform web surfing or various searches, and thus the Internet usage time is significantly increasing. Accordingly, there is an increasing number of cases of setting a bookmark to revisit a web page visited by a user later.

That is, bookmarks are also referred to as so-called “favorites” and, generally, the bookmarks are made in the form of storing an address of a corresponding web page on a web browser so that the web page, such as a web page showing results of a user's search, a web page containing content corresponding to the user's area of interest, a web page displaying products of interest in Internet shopping malls, or the like, may be easily retrieved later.

However, the conventional bookmarks are saved on the web browser by default, and thus there is a problem in that, when the user uses another web browser or uses another personal computer (PC), the bookmarks saved by the user cannot be used unless the operation of importing the previously saved bookmarks is performed.

In addition, generally, as the Internet usage time increases, the number of bookmarks saved on the web browser naturally increases. However, there is a problem in that, when the number of bookmarks saved in this way increases excessively, it becomes difficult to retrieve the required bookmark. In order to solve the above-problem, conventionally, a bookmark management system and method that replaces the saving of bookmarks and management of the saved bookmarks have been proposed.

Here, as an example of the related art for the bookmark management system and method as described above, for example, in Korean Patent Application Publication No. 10-2015-0034466, a method of generating a bookmark chain, which includes: searching a predetermined web page through a web browser; receiving a user's bookmark registration instruction; registering a current webpage as a bookmark in response to the registration instruction; analyzing a HyperText Markup Language (HTML) of the bookmarked web page and extracting information about the web page; extracting bookmark management information of the bookmarked web page from the web browser; searching for a bookmark and a bookmark chain associated with the web page information and the bookmark management information; and when the bookmark associated with the web page information and the bookmark management information is retrieved, generating a bookmark chain including information about a link for connecting the retrieved bookmark, wherein it is more conveniently browse the web page and manage the bookmark using a mobile terminal, etc. so that convenience of the user is improved, has been proposed.

Further, as another example of the related art for the bookmark management system and method as described above, for example, in Korean Patent Registration No. 10-0373690, a bookmark system using the Internet, which includes: a website registration unit including a database unit having basic member information, analyzed website information, and bookmark information for each account, a login management unit that transmits log information of the website included in the bookmark information for each account to a user when the user logs in using the basic member information when accessing through the Internet and requests access to the bookmarked website of the user, and a bookmark management unit that registers in the database unit when the user requests a bookmark for a specific website and outputs when the user requests the bookmark information, wherein the website registration unit analyzes information about a website connected to the Internet and registers information necessary for bookmarking of the database unit in the website information; a bookmark server including an input and output unit to or from which information is input or output through the Internet and a web control unit that controls each unit to perform a corresponding function when the user requests through the input and output unit and outputs a requested result; and a client server including a communication unit through which the user accesses the Internet for communication with the bookmark server, and which requests registration of the bookmark from the bookmark server through the Internet and accesses a specific website by using the registered bookmark information, wherein the bookmark system using the Internet is configured so that the user uses the bookmark information in the same environment without restriction of a location by sharing the bookmark information on the bookmark server with the user's computer through a dedicated program trayed separately from a browser, has been proposed.

As described above, conventionally, various technological contents have been presented for the bookmark management system and method. However, the bookmark management systems and methods of the related art as described above are merely replacing bookmark saving and management through an Internet server and are not significantly different from the conventional bookmark method performed on a web browser in saving and managing bookmarks.

That is, recently, instead of setting the bookmark for each web page as described above, when users retrieve useful information while using the Internet, the users are increasingly posting an arbitrary comment to comments on the corresponding web page and then accessing the web page again by using a “Comment I wrote” function.

However, there is the same problem in that, even in the case of using the comment function in this way, it is possible to check only after logging in and is relatively inconvenient compared to the bookmark, and management becomes difficult as the number of comments increases.

In addition, based on the fact that the information retrieved by the user through the search is the basis for the generation of the bookmark, it is expected that when the search function, which is the basis for the generation of the bookmark, is provided, not just the management of the bookmark, a more improved Internet experience may be provided to users. However, until now, a device or method that satisfies all such demands has not been provided.

### Document of Related Art

1. Korean Patent Application Publication No. 10-2015-0034466 (Published on Apr. 3, 2015)
2. Korean Patent Registration No. 10-0373690 (Published on Feb. 12, 2003)

### DISCLOSURE

### Technical Problem

The present invention is directed to providing a bookmark management and information search service providing system in which, in order to resolve problems of the conventional bookmark system and method which are difficult to manage and inconvenient to use as the number of bookmarks increases because a bookmark should be set for each web page that a user visits, a bookmark for a corresponding web page is simply settable by clicking an address of a bookmark management website, saved bookmarks are easily manageable, and the bookmarks are easily sharable with another user, and a bookmark management and information search service providing method using the same.

The present invention is also directed to providing a bookmark management and information search service providing system, in which a user is allowed to more conveniently save and use bookmarks and, at the same time, when the user enters a search word, the search word is analyzed and results retrieved from a plurality of preset search engines and websites are provided simultaneously, when the website is a website in a foreign language, the content of the website is automatically translated into the content in a native language, and thus the user may also rapidly and easily receive a desired search result, and a bookmark management and information search service providing method using the same.

### Technical Solution

One aspect of the present invention provides a bookmark management and information search service providing system including a server configured to provide a bookmark management and information search service, wherein the server includes: a bookmark service providing unit, which includes a bookmark registration processing module configured to perform a process of saving a bookmark and registering the bookmark according to a request of a user, which is received from a user terminal, and includes a bookmark access processing module configured to perform a process of bookmark access including managing, searching, and sharing the saved bookmark so as to perform overall processes for the bookmark such as the managing, searching, and sharing of the bookmark; and a search service providing unit configured to perform overall processes for a search service in which a corresponding search word is analyzed based on a user's search request or an input search word, a search is performed, and a result of the search is provided to the corresponding user terminal.

Here, the bookmark registration processing module may be configured to perform a process in which, when the user moves to a service website by clicking a link of the service website for bookmark management and an information search present on a web page to be bookmarked while using the Internet through his or her own user terminal, clicking an image in which the link of the service website is embedded, or clicking a link corresponding to the link of the service website posted in a comment when an address of the service website is not present, a referrer generated during the movement is analyzed and a uniform resource locator (URL) is extracted, and a website corresponding to the URL is accessed and information about the website is collected through website crawling, when the corresponding website is a website in a foreign language, the content of the corresponding website is translated into the content in a preset language, the information about the website is processed, and when whether to specify a keyword for the corresponding website is requested from the user terminal and then the keyword input by the user is received from the user terminal, an identification (ID) of the corresponding user, the extracted URL, the input keyword, and the extracted or collected information about the website are stored in a database.

Further, the bookmark access processing module may be configured to perform a process in which, when the user logs in the service website through his or her own user terminal, a list of bookmarks saved by the corresponding user is displayed for the logged-in user, when the user selects a specific bookmark from the displayed list of the bookmarks, the web page is moved to a URL corresponding to the selected bookmark, when the user enters the keyword while logging in the service website, a search for the bookmark saved by the corresponding user in the database is performed with the input keyword, and when a bookmark corresponding to the keyword is retrieved, the web page is moved to a URL corresponding to the retrieved bookmark.

In addition, the bookmark access processing module may be configured to perform a process in which, when a shortened address including an ID and a keyword is received from the user terminal, the ID and the keyword are extracted from the received content, the database is searched for the extracted ID and the keyword, and whether sharing is set for the retrieved ID is checked, when it is confirmed that the sharing is set, the web page is moved to a URL corresponding to a bookmark retrieved for the keyword, and when it is confirmed that whether the sharing is not set, a guide message indicating that processing is not possible because the sharing is not set is displayed.

In addition, the bookmark access processing module may be configured to perform a process in which, when a shortened address including a keyword is received from the user terminal, the keyword is extracted from the received content and whether the user of the corresponding user terminal has logged in is checked, when it is confirmed that the user has logged in, the list of bookmarks is retrieved for the corresponding user and the web page is moved to a URL corresponding to the retrieved bookmark, and when it is confirmed that the user has not logged in, a corresponding keyword is retrieved from the database and the web page is moved to a URL corresponding to the retrieved keyword.

Further, the search service providing unit may be configured to perform a process in which, when the user enters the search word (or the keyword) through his or her own user terminal, a search is performed for the corresponding search word through a preset web site and a search engine and each search result is displayed to the user, and thus the user receives a result retrieved from the website and the search engine through only one search.

In addition, the search service providing unit may be configured to perform a process in which a search is performed on a plurality of preset search engines and web sites for the input keyword and, at the same time, when the web site is the web site in the foreign language, the content of the corresponding website is automatically translated into the content in the preset language and a result of the translation is provided.

In addition, the search service providing unit may be configured to perform a process in which, when a specific keyword and a website and a search engine related to the specific keyword are allowed to match in advance and then the keyword for a search is input through the user terminal, a search is performed on a website and a search engine matching the input keyword through keyword analysis.

Further, the search service providing unit may be configured to perform a process in which, using artificial intelligence (AI), the specific keyword and the keyword input by each user are allowed to match, training is performed on the website and the search engine and the website on which the search is performed based on a degree of association, and a search is automatically performed with the input keyword on the basis of a result of the training.

In addition, the search service providing unit may be configured to perform a process in which, when the user presses a search setting button, a search website setting screen is displayed and the user freely sets a search website on which a search for each technical field or item is to be performed.

In addition, the search service providing unit may be configured to perform a process in which, when the user registers the service website as a search engine used in a web browser, the user does not need to access the service website for a search and uses a search function through an address bar of the web browser or uses a search in a URL format including the search keyword.

Another aspect of the present invention provides a bookmark management and information search service providing method in which a bookmark management and information search service is provided using the bookmark management and information search service providing system described above, the bookmark management and information search service providing method includes: providing a bookmark service, which includes a process of saving a bookmark and registering the bookmark according to a request of a user, which is received from a user terminal, and a process of managing, searching, and sharing of the saved bookmark and in which overall processes for the bookmark such as the generating, saving, and managing of the bookmark are performed; and providing a search service in which overall processes for a search service in which a corresponding search word is analyzed based on a user's search request or an input search word, a search is performed, and a result of the search is provided to the corresponding user terminal are performed.

Here, the providing of the bookmark service may include: when the user moves to a service website by clicking a link of the service website for bookmark management and an information search present on a web page to be bookmarked while using the Internet through his or her own user terminal, clicking an image in which the link of the service website is embedded, or clicking a link corresponding to the link of the service website posted in a comment when an address of the service website is not present, analyzing a referrer generated during the movement to extract a URL; accessing a website corresponding to the URL to collect information about the web site through web site crawling; when the corresponding web site is a web site in a foreign language, translating the content of the corresponding website into the content in a preset language to process the information about the website; and when whether to specify keyword for the corresponding website is requested from the user terminal and then the keyword input by the user is received from the user terminal, storing an ID of the corresponding user, the extracted URL, the input keyword, and the extracted or collected information about the website in a database.

In addition, the providing of the bookmark service may include: when a shortened address including an ID and a keyword is received from the user terminal, extracting the ID and the keyword from the received content; searching the database for the extracted ID and the keyword and checking whether sharing is set for the retrieved ID; when it is confirmed that the sharing is set, the web page is moved to a URL corresponding to the bookmark retrieved for the keyword; and when it is confirmed that whether the sharing is not set, displaying a guide message indicating that processing is not possible because the sharing is not set.

In addition, the providing of the search service may include: when the user enters a search word (or a keyword) through his or her own user terminal, performing a search for the corresponding search word through a preset web site and a search engine and displaying each search result to the user; and when the website is a website in a foreign language, automatically translating the content of the website into the content in a preset language and providing a result of the translation, and thus the user receives a result retrieved from the website and the search engine through only one search.

Further, the providing of the search service may include, when a specific keyword and a website and a search engine related to the specific keyword are allowed to match in advance and then a keyword for a search is input through the user terminal, performing a search on a web site and a search engine matching the input keyword through keyword analysis.

### Advantageous Effects

As described above, according to the present invention, a bookmark management and information search service providing system, in which it is possible to set a bookmark for a corresponding web page simply by clicking an address of a bookmark management website, to easily manage saved bookmarks, and to easily share the bookmark with another user, and a bookmark management and information search service providing method using the same can be provided. Therefore, problems of the conventional bookmark system and method, which are difficult to manage and inconvenient to use as the number of bookmarks increases because a bookmark should be set for each web page that a user visits, can be resolved.

Further, according to the present invention, as described above, a bookmark management and information search service providing system in which, when the user enters a search word, the search word is analyzed and results retrieved from a plurality of preset search engines and websites are provided simultaneously, when the website is a website in a foreign language, the content of the website is automatically translated into the content in a native language, and a bookmark management and information search service providing method using the same can be provided. Therefore, the user can save and use the bookmarks more conveniently and can rapidly and easily receive a desired search result.

### DESCRIPTION OF DRAWINGS

FIG. 1 is a schematic diagram illustrating an overall configuration of a bookmark management and information search service providing system according to an embodiment of the present invention.

FIG. 2 is a schematic diagram illustrating a specific configuration of a server of the bookmark management and information search service providing system illustrated in FIG. 1 according to the embodiment of the present invention.

FIG. 3 is a schematic flowchart illustrating the overall operations of bookmark registration processing performed when a bookmark service is provided in the bookmark management and information search service providing system illustrated in FIG. 1 according to the embodiment of the present invention.

FIG. 4 is a schematic flowchart illustrating the overall operations of bookmark access processing performed when the bookmark service is provided in the bookmark management and information search service providing system illustrated in FIG. 1 according to the embodiment of the present invention.

FIG. 5 is a schematic flowchart illustrating the overall operations of search service processing performed when a search service is provided in the bookmark management and information search service providing system illustrated in FIG. 1 according to the embodiment of the present invention.

FIG. 6 is a schematic diagram illustrating an example of displaying a main screen which is displayed when a user accesses the bookmark management and information search service providing system illustrated in FIG. 1 according to the embodiment of the present invention.

FIG. 7 is a schematic diagram illustrating an example of displaying a search setting screen for setting a search website for each field in the bookmark management and information search service providing system illustrated in FIG. 1 according to the embodiment of the present invention.

### MODES OF THE INVENTION

Hereinafter, specific embodiments of a bookmark management and information search service providing system and method according to the present invention will be described with reference to the accompanying drawings.

Here, it should be noted that the contents described below are only one embodiment for embodying the present invention and the present invention is not limited only to the contents of the embodiments described below.

In addition, in the following description of the embodiments of the present invention, it should be noted that, in order to simplify the description, detailed descriptions thereof have been omitted for the part that is the same or similar to the content of the related art, or is determined to be easily understood and implemented at the level of those skilled in the art.

That is, as will be described below, the present invention relates to a bookmark management and information search service providing system in which, in order to resolve problems of the conventional bookmark system and method which are difficult to manage and inconvenient to use as the number of bookmarks increases because a bookmark should be set for each web page that a user visits, a bookmark for a corresponding web page is simply settable by clicking an address of a bookmark management website, saved bookmarks are easily manageable, and the bookmarks are easily sharable with another user, and a bookmark management and information search service providing method using the same.

In addition, as will be described below, the present invention relates to a bookmark management and information search service providing system, in which a user is allowed to more conveniently save and use bookmarks and, at the same time, when the user enters a search word, the search word is analyzed and results retrieved from a plurality of preset search engines and websites are provided simultaneously, when the website is a website in a foreign language, the content of the website is automatically translated into the content in a native language, and thus the user may also rapidly and easily receive a desired search result, and a bookmark management and information search service providing method using the same.

Subsequently, specific contents of the bookmark management and information search service providing system and method according to the present invention will be described with reference to the accompanying drawings.

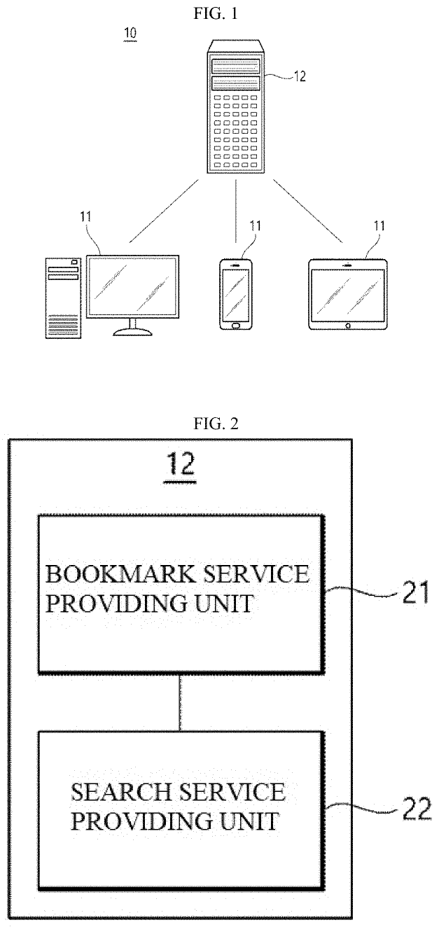

First, referring to FIGS. 1 and 2, FIG. 1 is a schematic diagram illustrating an overall configuration of a bookmark management and information search service providing system 10 according to the embodiment of the present invention, and FIG. 2 is a schematic diagram illustrating a specific configuration of a server 12 of the bookmark management and information search service providing system 10 illustrated in FIG. 1 according to the embodiment of the present invention.

As illustrated in FIG. 1, the bookmark management and information search service providing system 10 according to the embodiment of the present invention may include a plurality of user terminals 11 including clients personal computers (PC) capable of accessing the Internet or personal portable information communication terminals such as smartphones, tablet PCs, or the like, and a server 12 that receives various types of requests for bookmark and search services from each user terminal 11 and provides a service according to each request to a corresponding user terminal 11.

Here, as illustrated in FIG. 2, the server 12 may include a bookmark service providing unit 21 that performs overall processes for a bookmark such as generation, saving, and management of the bookmark, and a search service providing unit 22 that performs overall processes for a search service in which a corresponding search word is analyzed based on a user's search request or an input search word, a search is performed, and a result of the search is provided to the user.

Further, each of the user terminal 11 and the server 12 described above may be implemented in the form of dedicated hardware, but preferably, may be easily implemented with a low cost by installing a dedicated application and program configured to perform a series of processing processes as described above on a PC capable of accessing the Internet or a personal portable information communication terminal such as a smartphone or a tablet PC, and on a server device.

In addition, the server 12 may include the bookmark service providing unit 21 and the search service providing unit 22 which are modularized into separate processing modules to perform a series of processing processes as described below, and thus it may be easy to implement the entire system and, at the same time, it may be easy to manage and maintain the entire system and to add and change functions thereof.

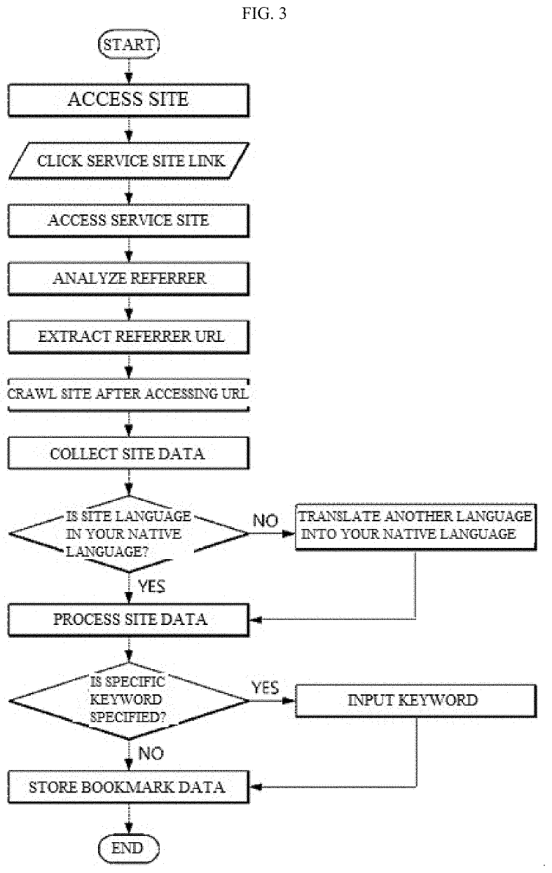

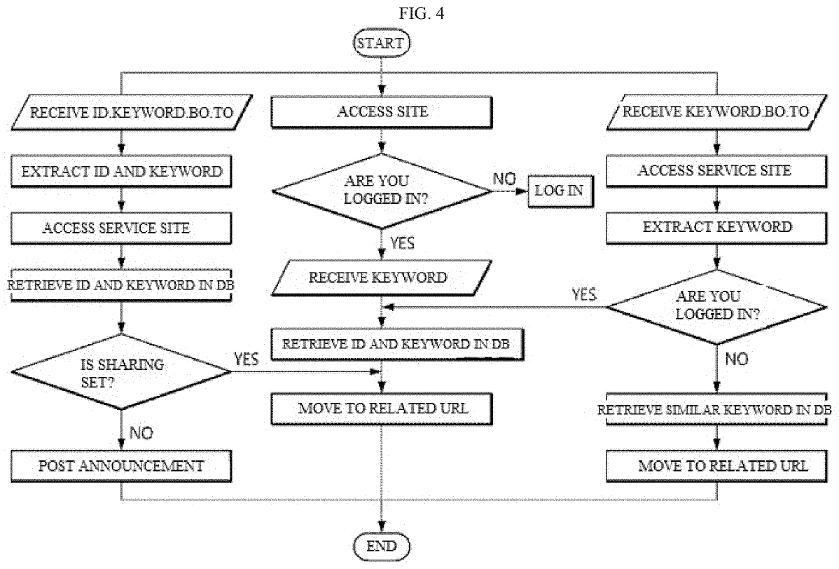

More specifically, referring to FIGS. 3 and 4, FIGS. 3 and 4 are schematic flowcharts illustrating overall operations performed when a bookmark service is provided in the bookmark management and information search service providing system 10 illustrated in FIG. 1 according to the embodiment of the present invention. FIG. 3 is a schematic flowchart illustrating the overall operations of bookmark registration processing, and FIG. 4 is a schematic flowchart illustrating the overall operations of bookmark access processing.

As illustrated in FIGS. 3 and 4, in the bookmark management and information search service providing system 10 according to the embodiment of the present invention, specific operations performed when the bookmark service is provided may include a bookmark registration process in which a process of saving bookmarks in a service website is performed, and a bookmark access process in which a process of managing saved bookmarks, searching saved addresses, accessing a selected bookmark, and sharing the bookmark with another user is performed.

That is, although not illustrated, the bookmark service providing unit 21 illustrated in FIG. 2 may include a bookmark registration processing module in which a process of bookmark registration such as saving the bookmark is performed in response to a user's request and the like, and a bookmark access processing module in which a process of bookmark access such as managing, searching, and sharing the saved bookmark is performed.

More specifically, first, in the case of saving the bookmark, as illustrated in FIG. 3, when the user moves to a service website by clicking a link of the service website for bookmark management and an information search present on a web page to be bookmarked while using the Internet through his or her own user terminal 11, clicking an image in which a link of a service website is embedded, or clicking a link corresponding to a link of a service web site posted in a comment when an address of the service website is not present, referrer data is generated during this process.

In this case, the server 12 may analyze the referrer data generated during the movement to extract a uniform resource locator (URL), access the corresponding website, and collect information about the corresponding website through website crawling or the like. When the corresponding web site is a web site in a foreign language, the server 12 may translate a title and contents into a title and contents in a pre-specified language such as a native language to process the website information and request whether to specify a keyword for the corresponding website from the user. When the keyword is input by the user, the server 12 may store bookmark data associated with the user's identification (ID), the URL, the keyword, and web site information in a database.

Therefore, as described above, the server 12 may be configured to include a specific keyword, a shortened address, or the like which is input by the user when saving the bookmark, thereby further improving the convenience and safety of use.

More specifically, conventionally, there are many problems in that the bookmarks are simply saved with a website name or a simple phrase so that even when the saved contents are viewed after a period of time has elapsed, it is not possible to exactly remember the contents. However, in the present invention, in order to solve the above problems, the keywords are inserted for users to understand or the bookmark is generated and saved in the form of shortened addresses, such as “http://OOUniversity.Example 01.bo.to,” “http://NationalTaxService.NoticeNo2018.bo.to,” “http://OOParcelService.DeliveryInquiry.bo.to,” “http://OOShoppingMall.XXItem.PriceComparisonResult.bo.to,” or the like. Therefore, it is easy to search for and type the saved bookmarks, and, at the same time, it is easy for the user to check the contents of the bookmark at one time and go back to the contents even after a period of time has passed.

In addition, as described above, the contents of the shortened address are easily understood at a glance, and thus it is possible to prevent a security problem such as the distribution of malicious code or the leakage of personal information due to false or forged shortened addresses which is currently problematic.

Therefore, as described above, the bookmark may be generated through the address of the service website, the bookmark saved in this way may be easily called in a domain manner anytime, anywhere through each user's account, and the users may share the bookmark or collect big data for each link to provide the data in the form of a portal. Therefore, compared to the bookmark function provided by the conventional web browser or portal website, the bookmark may be saved and managed more simply and conveniently.

Here, a Hypertext Transfer Protocol (HTTP) referrer refers to a trace left when visiting each web site through a hyperlink when surfing the Internet with a web browser. For example, when there is a hyperlink from website A to website B and the user clicks a corresponding hyperlink, the web browser transmits a reference address (or a referrer) to the web site B and a manager of the web site B may know that a visitor visited his or her web site through the web site A using the transmitted referrer, and thus the referrer is useful when the manager of the web site B wants to know a path by which the website visitor visited his or her website.

In addition, as described above, more specific details about the process of extracting the URL and generating the bookmark using the referrer are obvious to those skilled in the art. Therefore, in the present invention, it should be noted that detailed descriptions thereof are omitted in order to simplify the description of contents that may be easily understood and implemented by those skilled in the art with reference to the documents of the related art as described above.

Next, in the case of using the saved bookmark, as illustrated in FIG. 4, first, when the user accesses the server 12 (i.e., the service website) through his or her own user terminal 11 and logs in, the server 12 displays a list of the bookmarks saved by the corresponding user for the logged-in user, and when a specific bookmark is selected from the displayed list, the server 12 moves the current web page to a web page corresponding to the selected bookmark. In this case, when the number of saved bookmarks is large, the server 12 may be configured to receive a keyword and retrieve a desired bookmark through search.

Further, in order to share the bookmark, as illustrated in FIG. 4, when the server 12 receives a shortened address including an ID and a keyword, such as “ID.Keyword.bo.to,” the server 12 may extract the ID and the keyword from the received content, search for the ID and the keyword stored in the service website, move the current web page to a corresponding URL when it is confirmed that sharing is set, and perform a process of displaying a guide message for the corresponding content when it is confirmed that sharing is not set.

Alternatively, in another way, when the server 12 receives a shortened address including only a keyword, such as “Keyword.bo.to,” the server 12 may extract the keyword from the received content and check whether the user has logged in the service website. When it is confirmed that the user has logged in the service website, the server 12 may search for the list of the bookmarks for the corresponding user and move the current web page to a corresponding URL, and when it is confirmed that the user has not logged in the service website, the server 12 may retrieve the keyword in the service website and perform a process of moving the current web page to a retrieved related URL.

Therefore, with the configuration as described above, the user may conveniently use the bookmarks saved by himself or herself through logging in and may share the bookmark with another user through the ID and the keyword. In this case, the bookmark may be shared using only the keyword without logging in.

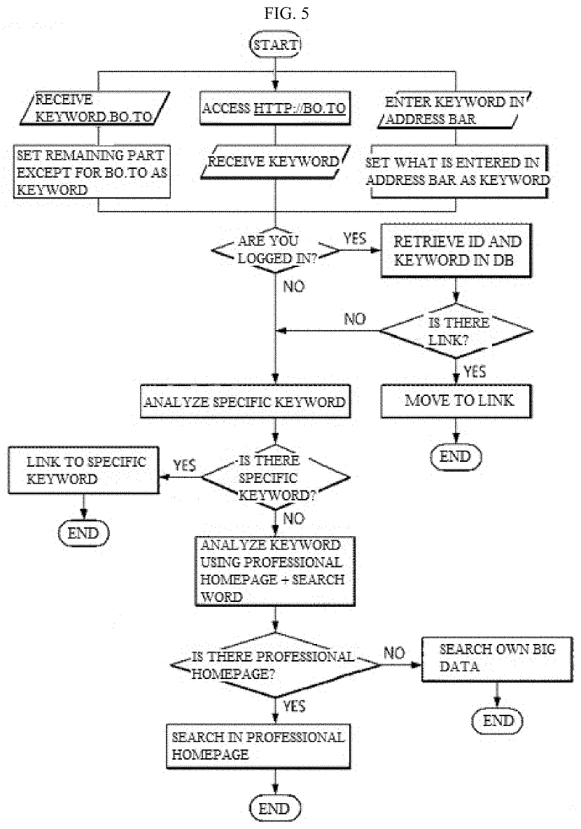

Subsequently, referring to FIG. 5, FIG. 5 is a schematic flowchart illustrating the overall operations of search service processing performed when a search service is provided in a search service providing unit 22 of the bookmark management and information search service providing system 10 illustrated in FIG. 1 according to the embodiment of the present invention.

As illustrated in FIG. 5, in the case in which the user wants to use a search service, when the user logs in the server 12 (i.e., the service website) through his or her own user terminal 11 or when the user enters a search word (or a keyword) in a search box without logging in, the server 12 may search for the corresponding search word through a preset search website and a search engine and display each search result to the user, and thus the server 12 may simultaneously provide search results by a plurality of search websites and the search engine rather than a search result by a single search website or search engine.

Further, for example, when a keyword “Patent” is input, an information search web site (http://www.kipris.or.kr) of the Korean Intellectual Property Office is processed to be retrieved. In the case in which there is a specialized website for a specific field, when a keyword of the corresponding field is input, it may be configured to perform a search on the specialized website in the field through keyword analysis. In this way, when a specific keyword and a website and a search engine related to the specific keyword are allowed to match in advance and then a keyword for a search is input through the user terminal, it may be configured to perform a process of performing a search on a web site and a search engine matching the input keyword through keyword analysis. Therefore, when a keyword in a specialized field is input rather than a general simple search, it may be configured to obtain a desired search result more easily, rapidly, and accurately even when the user does not know the specialized website in the corresponding field.

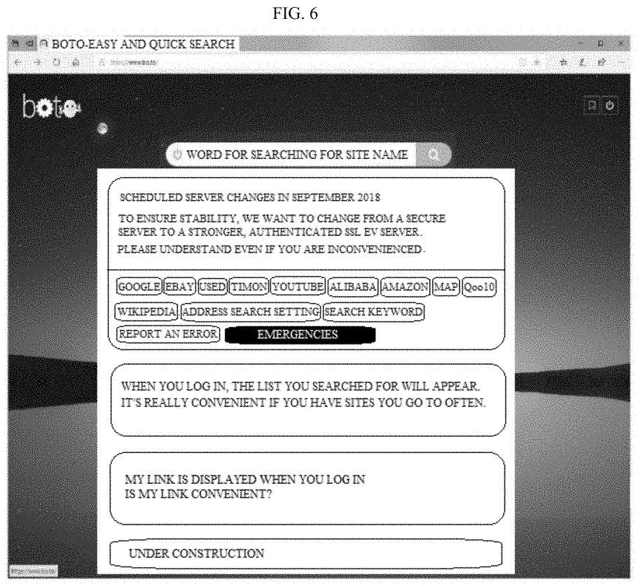

More specifically, referring to FIG. 6, FIG. 6 is a schematic diagram illustrating an example of displaying a main screen which is displayed when a user accesses the bookmark management and information search service providing system 10 illustrated in FIG. 1 according to the embodiment of the present invention.

As illustrated in FIG. 6, in the bookmark management and information search service providing system 10 according to the embodiment of the present invention, when a user accesses the server 12, that is, the service website, the main screen is displayed on the user terminal 11 as illustrated in FIG. 6, and the user may log in to use a bookmark service and a search service or enter a keyword in a search box without logging in to use the search service.

In this case, as illustrated in FIG. 6, since various types of search engines or search websites are preset, a search may be simultaneously performed for websites which are set with respect to the input keyword. In this case, when the website is a website in a foreign language, it may be configured to automatically translate the content of the website into the content in a preset language and to provide a result of the translation, and thus a search for websites around the world may be made more rapidly and easily.

Here, the setting of the search website as described above may be initially set in advance by a service provider, but preferably, using artificial intelligence (AI), it may be configured to automatically determine a website on which a search is performed for keywords input by the users and the keyword input through learning with respect to the websites on which the search is performed, and to perform a process of performing a search on the website.

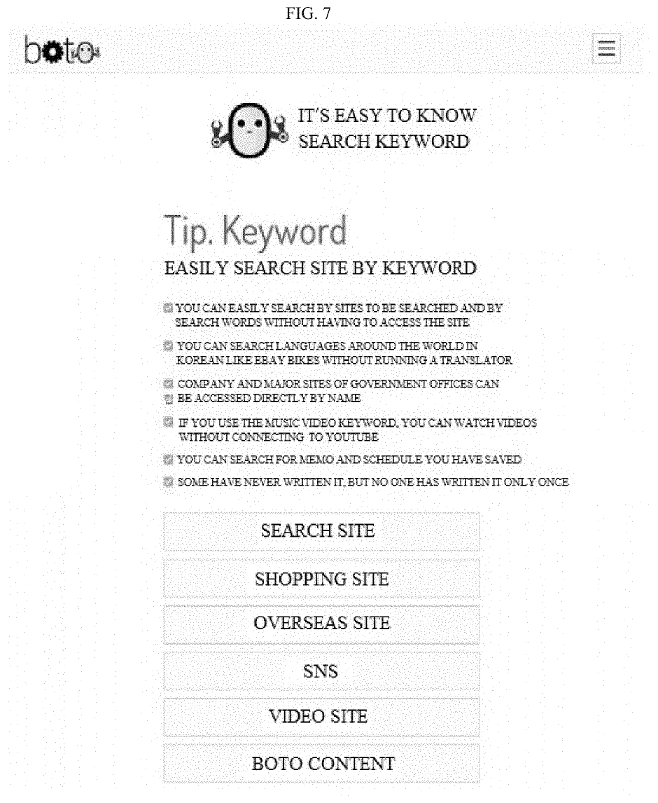

In addition, the setting of the search website as described above may be configured so that the user may freely set the search web site using a separate setting button. That is, referring to FIG. 7, FIG. 7 is a schematic diagram illustrating an example of displaying a search setting screen for setting a search website for each field in the bookmark management and information search service providing system 10 illustrated in FIG. 1 according to the embodiment of the present invention.

As illustrated in FIG. 7, when the user presses a search setting button on the main screen, it may be configured that the setting screen as illustrated in FIG. 7 may be displayed so that detailed settings for a website on which a search is performed for each item are possible.

Further, the above-described search function is not necessarily available when accessing the service website. That is, for example, the user may not need to individually access the service website for a search and may easily use the above-described search function through an address bar of the web browser by simply registering the service website with a search engine in the web browser.

Therefore, with the configuration as described above, the user may not need to repeatedly search the same contents through each search web site or search engine and may receive various search results with only one search, and thus the desired search results may be obtained more rapidly and easily.

Here, in the above-described embodiment of the present invention, the present invention has been described with reference to FIGS. 1 to 7 as an example in which the present invention is configured as described above, but the present invention is not limited to the above case. That is, it should be noted that the present invention may be configured in various forms as necessary in addition to the case of the above-described embodiment with reference to FIGS. 1 to 7.

Therefore, as described above, the bookmark management and information search service providing system and the bookmark management and method according to the present invention can be implemented.

Further, by implementing the bookmark management and information search service providing system and method according to the present invention as described above, according to the present invention, a bookmark management and information search service providing system, in which it is possible to set a bookmark for a corresponding web page simply by clicking an address of a bookmark management website, to easily manage saved bookmarks, and to easily share the bookmark with another user, and a bookmark management and information search service providing method using the same can be provided. Therefore, problems of the conventional bookmark system and method, which is difficult to manage and inconvenient to use, as the number of bookmarks increases because a bookmark should be set for each web page that a user visits, can be resolved.

In addition, according to the present invention, as described above, a bookmark management and information search service providing system, in which, when the user enters a search word, the search word is analyzed and results retrieved from a plurality of preset search engines and websites are provided simultaneously, when the website is a website in a foreign language, the content of the website is automatically translated into the content in a native language, and a bookmark management and information search service providing method using the same can be provided. Therefore, the user can save and use the bookmarks more conveniently and can rapidly and easily receive a desired search result.

In the above, the detailed contents of the bookmark management and information search service providing system and method according to the present invention have been described through the embodiments of the present invention as described above, but the present invention is not limited to the contents described in the above-described embodiments. Therefore, it is natural that various modifications, changes, combinations, and substitutions are possible according to design needs and other various factors by those skilled in the art to which the present invention pertains.

### REFERENCE NUMERALS

10: BOOKMARK MANAGEMENT AND INFORMATION SEARCH SERVICE PROVIDING SYSTEM
11: USER TERMINAL
12: SERVER
21: BOOKMARK SERVICE PROVIDING UNIT
22: SEARCH SERVICE PROVIDING UNIT

1. A bookmark management and information search service providing system including a server configured to provide a bookmark management and information search service, wherein the server includes:
a bookmark service providing unit, which includes a bookmark registration processing module configured to perform a process of saving a bookmark and registering the bookmark according to a request of a user, which is received from a user terminal and includes a bookmark access processing module configured to perform a process of bookmark access including managing, searching, and sharing the saved bookmark so as to perform overall processes for the bookmark such as the managing, searching, and sharing of the bookmark; and
a search service providing unit configured to perform overall processes for a search service in which a corresponding search word is analyzed based on a user's search request or an input search word, a search is performed, and a result of the search is provided to the corresponding user terminal.

2. The bookmark management and information search service providing system of claim 1, wherein the bookmark registration processing module is configured to perform a process in which, when the user moves to a service website by clicking a link of the service website for bookmark management and an information search present on a web page to be bookmarked while using the Internet through his or her own user terminal, clicking an image in which the link of the service website is embedded, or clicking a link corresponding to the link the a service website posted in a comment when an address of the service website is not present, a referrer generated during the movement is analyzed and a uniform resource locator (URL) is extracted, and a website corresponding to the URL is accessed and information about the website is collected through website crawling, when the corresponding website is a website in a foreign language, the content of the corresponding website is translated into the content in a preset language, the information about the website is processed, and when whether to specify a keyword for the corresponding website is requested from the user terminal and then the keyword input by the user is received from the user terminal, an identification (ID) of the corresponding user, the extracted URL, the input keyword, and the extracted or collected information about the website are stored in a database.

3. The bookmark management and information search service providing system of claim 2, wherein the bookmark access processing module is configured to perform a process in which, when the user logs in the service website through his or her own user terminal, a list of bookmarks saved by the corresponding user is displayed for the logged-in user, when the user selects a specific bookmark from the displayed list of the bookmarks, the web page is moved to a URL corresponding to the selected bookmark, when the user enters the keyword while logging in the service web site, a search for the bookmark saved by the corresponding user in the database is performed with the input keyword, and when a bookmark corresponding to the keyword is retrieved, the web page is moved to a URL corresponding to the retrieved bookmark.

4. The bookmark management and information search service providing system of claim 3, wherein the bookmark access processing module is configured to perform a process in which, when a shortened address including an ID and a keyword is received from the user terminal, the ID and the keyword are extracted from the received content, the database is searched for the extracted ID and the keyword, and whether sharing is set for the retrieved ID is checked, when it is confirmed that the sharing is set, the web page is moved to a URL corresponding to a bookmark retrieved for the keyword, and when it is confirmed that whether the sharing is not set, a guide message indicating that processing is not possible because the sharing is not set is displayed.

5. The bookmark management and information search service providing system of claim 4, wherein the bookmark access processing module is configured to perform a process in which, when a shortened address including a keyword is received from the user terminal, the keyword is extracted from the received content and whether the user of the corresponding user terminal has logged in is checked, when it is confirmed that the user has logged in, the list of bookmarks is retrieved for the corresponding user and the web page is moved to a URL corresponding to the retrieved bookmark, and when it is confirmed that the user has not logged in, a corresponding keyword is retrieved from the database and the web page is moved to a URL corresponding to the retrieved keyword.

6. The bookmark management and information search service providing system of claim 2, wherein the search service providing unit is configured to perform a process in which, when the user enters the search word (or the keyword) through his or her own user terminal, a search is performed for the corresponding search word through a preset web site and a search engine and each search result is displayed to the user, and thus the user receives a result retrieved from the website and the search engine through only one search.

7. The bookmark management and information search service providing system of claim 6, wherein the search service providing unit is configured to perform a process in which a search is performed on a plurality of preset search engines and web sites for the input keyword and, at the same time, when the web site is the web site in the foreign language, the content of the corresponding website is automatically translated into the content in the preset language and a result of the translation is provided.

8. The bookmark management and information search service providing system of claim 7, wherein the search service providing unit is configured to perform a process in which, when a specific keyword and a website and a search engine related to the specific keyword are allowed to match in advance and then the keyword for a search is input through the user terminal, a search is performed on a website and a search engine matching the input keyword through keyword analysis.

9. The bookmark management and information search service providing system of claim 8, wherein the search service providing unit is configured to perform a process in which, using artificial intelligence (AI), the specific keyword and the keyword input by each user are allowed to match, training is performed on the website and the search engine and the website on which the search is performed based on a degree of association, and a search is automatically performed with the input keyword on the basis of a result of the training.

10. The bookmark management and information search service providing system of claim 9, wherein the search service providing unit is configured to perform a process in which, when the user presses a search setting button, a search website setting screen is displayed and the user freely sets a search website on which a search for each technical field or item is to be performed.

11. The bookmark management and information search service providing system of claim 10, wherein the search service providing unit is configured to perform a process in which, when the user registers the service website as a search engine used in a web browser, the user does not need to access the service website for a search and uses a search function through an address bar of the web browser or uses a search in a URL format including the search keyword.

12. A bookmark management and information search service providing method includes:
providing a bookmark service, which includes a process of saving a bookmark and registering the bookmark according to a request of a user, which is received from a user terminal, and a process of managing, searching, and sharing of the saved bookmark and in which overall processes for the bookmark such as the generating, saving, and managing of the bookmark are performed; and
providing a search service in which overall processes for a search service in which a corresponding search word is analyzed based on a user's search request or an input search word, a search is performed, and a result of the search is provided to the corresponding user terminal are performed.

13. The bookmark management and information search service providing method of claim 12, wherein the providing of the bookmark service includes:
when the user moves to a service website by clicking a link of the service website for bookmark management and an information search present on a web page to be bookmarked while using the Internet through his or her own user terminal, clicking an image in which the link of the service website is embedded, or clicking a link corresponding to the link of the service web site posted in a comment when an address of the service web site is not present, analyzing a referrer generated during the movement to extract a uniform resource locator (URL);
accessing a website corresponding to the URL to collect information about the web site through web site crawling;
when the corresponding website is a website in a foreign language, translating the content of the corresponding website into the content in a preset language to process the information about the website; and
when whether to specify a keyword for the corresponding website is requested from the user terminal and then the keyword input by the user is received from the user terminal, storing an identification (ID) of the corresponding user, the extracted URL, the input keyword, and the extracted or collected information about the website in a database.

14. The bookmark management and information search service providing method of claim 12, wherein the providing of the bookmark service includes:
when a shortened address including an ID and a keyword is received from the user terminal, extracting the ID and the keyword from the received content;
searching the database for the extracted ID and the keyword and checking whether sharing is set for the retrieved ID;
when it is confirmed that the sharing is set, the web page is moved to a URL corresponding to the bookmark retrieved for the keyword; and
when it is confirmed that whether the sharing is not set, displaying a guide message indicating that processing is not possible because the sharing is not set.

15. The bookmark management and information search service providing method of claim 12, wherein the providing of the bookmark service includes:
when the user enters a search word (or a keyword) through his or her own user terminal, performing a search for the corresponding search word through a preset website and a search engine and displaying each search result to the user; and
when the website is a website in a foreign language, automatically translating the content of the website into the content in a preset language and providing a result of the translation, and thus the user receives a result retrieved from the website and the search engine through only one search.

16. The bookmark management and information search service providing method of claim 12, wherein the providing of the bookmark service includes, when a specific keyword and a website and a search engine related to the specific keyword are allowed to match in advance and then a keyword for a search is input through the user terminal, performing a search on a web site and a search engine matching the input keyword through keyword analysis.
